(19) United States
(12) Patent Application Publication
(10) Pub. No.: US 2009/0029246 A1
(43) Pub. Date: Jan. 29, 2009

(54) Pouch-type secondary battery

(75) Inventor: Joongheon KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/176,486

(22) Filed: Jul. 21, 2008

(30) Foreign Application Priority Data
Jul. 23, 2007 (KR) 2007-73653

(51) Int. Cl. H01M 2/02; H01M 10/04; H01M 2/08

(52) U.S. Cl. 429/176; 429/246; 429/185

(57) ABSTRACT

A pouch-type secondary battery including: an electrode assembly including a positive electrode, a negative electrode, and a separator interposed therebetween; a pouch case housing the electrode assembly, having a sealing portion to seal at least at a part of the periphery of the pouch case; and a positive electrode tap and a negative electrode tap electrically connected to the positive electrode and the negative electrode, respectively. The electrode taps extend through the sealing portion, and out of the pouch case each. The secondary battery includes an insulator that covers at least portions of one or both of the electrode taps. The insulator can include hole that expose portions of the electrode taps.

### CROSS-REFERENCE TO RELATED APPLICATION

This application claims the benefits of Korean Application No. 2007-73653, filed Jul. 23, 2007, in the Korean Intellectual Property Office, the disclosure of which is incorporated herein by reference.

### BACKGROUND OF THE INVENTION

1. Field of the Invention

Aspects of the present invention relate to a pouch-type secondary battery, and more particularly, to a pouch-type secondary battery to prevent a short circuit caused by contact between a positive electrode tap and a negative electrode tap extended to the outside of the pouch-type secondary battery.

2. Description of the Related Art

Secondary batteries are widely used in small, high-tech, electronic devices, such as, cellular phones, PDAs, and notebook computers. In particular, lithium secondary batteries have an operation voltage of 3.6 V, which is three times higher than the operation voltage of nickel-cadmium batteries, and nickel-hydride batteries, which are generally used to power electronic devices. Lithium secondary batteries have an excellent energy density per unit weight, and therefore, the use of lithium secondary batteries has rapidly increased.

In lithium secondary batteries, a positive electrode active material and a negative electrode active material generally consist of a lithium based oxide and a carbon material, respectively. Further, lithium secondary batteries may be manufactured in various shapes. Representative shapes of lithium secondary batteries include cylindrical, prismatic, and pouch-type. According to the kind of an electrolyte used, lithium secondary batteries are classified as lithium ion batteries, which use a liquid electrolyte, and lithium polymer batteries, which use a polymer solid electrolyte. According to the type of polymer solid electrolyte, lithium polymer batteries may be divided into a completely solid type, which comprises no electrolyte, and a gel-type, which uses gel comprising an electrolyte.

Lithium polymer batteries, which use a polymer solid electrolyte, have an electrode assembly disposed in a metal foil pouch. The periphery of the pouch is sealed to secure the electrode assembly inside of the pouch. Further, a positive electrode tap and a negative electrode tap electrically connected to the electrode assembly, extend outside of the pouch, and are electrically connected to a Protective Circuit Module (PCM).

However, such conventional lithium secondary batteries are likely to cause a short circuit, due to contact between the positive electrode tap and the negative electrode tap. In particular, the smaller the size and a capacity of a pouch-type secondary battery, the narrower a gap between the positive electrode tap and the negative electrode tap becomes. Thus, the likelihood of a short circuit increases.

### SUMMARY OF THE INVENTION

Aspects of the present invention provide a pouch-type battery capable of preventing a short circuit between a positive electrode tap and a negative electrode tap.

A pouch-type secondary battery, according to aspects of the invention, comprises: an electrode assembly including a positive electrode, a negative electrode, and a separator interposed therebetween; a pouch case to house the electrode assembly, having a sealing portion to seal the pouch case; a positive electrode tap electrically connected to the positive electrode; and a negative electrode tap electrically connected to the negative electrode. The electrode taps each have an extended portion that extends to the outside of the pouch case, from the sealing portion. Free ends of the extended portions are covered with an insulator.

According to aspects of the present invention, the lengths of the free ends may be less than half of the length of the extended portions as a whole.

According to aspects of the present invention, the insulator may be a single unit which covers both the positive electrode tap and the negative electrode tap, or may be multiple units that separately cover each electrode tap.

According to aspects of the present invention, a polymer is applied to the positive electrode tap and the negative electrode tap, to insulate the electrode taps from a sealing portion of the pouch case. The extended portions of the positive electrode tap and the negative electrode tap may have a midsection that is not insulated, which is disposed between the free end and the polymer.

According to aspects of the present invention, the insulator may have holes that expose portions of the positive electrode tap and the negative electrode tap.

A pouch-type secondary battery, according to aspects of the invention, comprises: an electrode assembly including a positive electrode, a negative electrode, and a separator interposed therebetween; a pouch case to house the electrode assembly, having a sealing portion to seal the electrode assembly therein; a positive electrode tap and electrically connected to the positive electrode; and a negative electrode tap electrically connected to the negative electrode. The electrode taps extend from the electrode assembly, through the sealing portion, and outside of the pouch case. The electrode tabs have extended portions, which extend outside of the pouch case. One of the extended portions can be covered with an insulator.

According to aspects of the present invention, the insulators are formed around the positive electrode tap and the negative electrode tap, and may have holes that expose portions of the positive electrode tap, or the negative electrode tap.

A pouch-type secondary battery, according to aspects of the invention, comprises: an electrode assembly including a positive electrode, a negative electrode, and a separator interposed therebetween; a pouch case to house the electrode assembly, having a sealing portion to seal the electrode assembly therein; a positive electrode tap and electrically connected to the positive electrode; and a negative electrode tap electrically connected to the negative electrode. The electrode taps each have a extended portion that extends outside of the pouch case, through the sealing portion. The extended portions of the positive electrode tap and the negative electrode tap may each be entirely covered with an insulator. Holes may be formed in the insulators, to expose portions of the electrode taps.

According to aspects of the present invention, the holes may be formed on opposite sides of the electrode taps. Alternately, the holes may expose edges of the electrode taps.

A pouch-type secondary battery, according to an exemplary embodiment of the invention, prevents a short circuit caused by contact between a positive electrode tap and negative electrode tap.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a plan view of the secondary battery, according to an exemplary embodiment of the invention;

FIG. 2 is a plan view of the secondary battery, according to another exemplary embodiment of the invention;

FIG. 3 is a plan view of the secondary battery, according to still another exemplary embodiment of the invention;

FIG. 4 is a plan view of the secondary battery, according to still another exemplary embodiment of the invention;

FIG. 5 is a plan view of the secondary battery, according to still another exemplary embodiment of the invention;

FIG. 6 is a plan view of the secondary battery, according to still another exemplary embodiment of the invention;

FIG. 7 is a lateral view shown in the direction of “A” in FIG. 6;

FIG. 8 is a plan view of the secondary battery, according to still another exemplary embodiment of the invention;

FIG. 9 is a cross-sectional view taken along the line IX-IX of FIG. 8;

FIG. 10 is a cross-sectional view illustrating another exemplary embodiment with regard to a part of the secondary battery of FIG. 8;

FIG. 11 is a plan view of the secondary battery, according to still another exemplary embodiment of the invention; and

FIG. 12 is a plan view of the secondary battery, according to still another exemplary embodiment of the invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of present invention, by referring to the figures.

A secondary battery, according to aspects of the present invention, is exemplified as a pouch-type secondary battery, which has comparatively small capacity and volume, but the invention is not limited to hereto, and may be applied to a pouch-type secondary battery that has a standard capacity and volume.

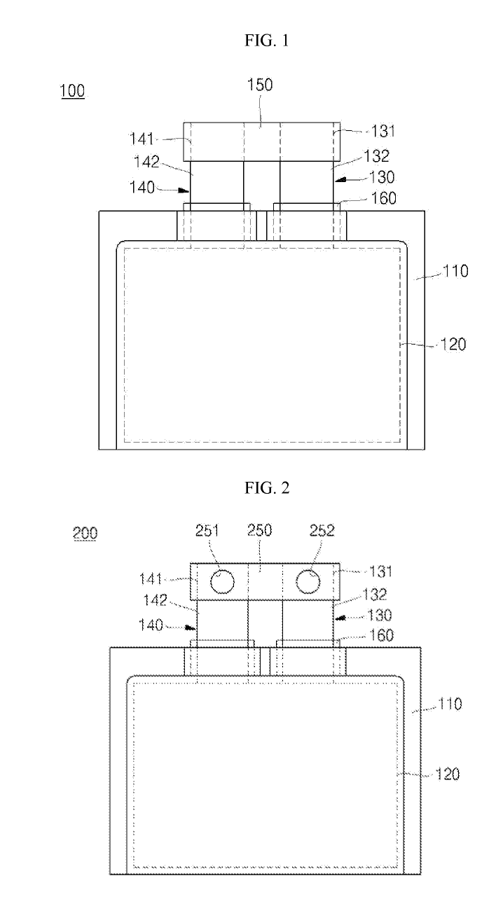

FIG. 1 is a plan view of a secondary battery 100, according to an exemplary embodiment of the invention. The secondary battery 100 comprises an electrode assembly 120, a pouch case 110, a positive electrode tap 130, a negative electrode tap 140, and an insulator 150.

The electrode assembly 120 includes a positive electrode, a negative electrode, and a separator interposed therebetween. The positive electrode and the negative electrode are generally plate shaped, and are wound into a jelly roll-type configuration. The positive electrode is coated with a positive electrode active material, and the negative electrode is coated with a negative electrode active material. Such a construction of the electrode assembly 120 corresponds to that of a general pouch-type secondary battery, and thus, a detailed drawing and description thereof, is omitted

The pouch case 110 houses the electrode assembly 120, and a sealing portion is formed around at least at a portion of the periphery thereof. The pouch case 110 has a metallic layer and a thermal adhesion layer. The sealing portion is formed by folding the pouch case 110, and thermally adhering the folded adhesion layer.

Fixed ends of the positive electrode tap 130 and negative electrode tap 140 are electrically connected to the positive electrode and negative electrode, respectively. The electrode taps 130, 140 extend through the sealing portion, and out of the pouch case 110. The electrode taps 130, 140 include free ends 131, 141, and midsections 132, 142. The midsections 132, 142 extend between the sealing portion and the free ends 131, 141. The midsections 132, 142 and the free ends 131, 141 can be collectively referred to as extended portions.

An insulator 150 covers the free ends 131, 141. The insulator 150 is a single unit that connects the free ends 131, 141. The insulator prevents the electrode taps 130, 140 from contacting one another, and forming a short circuit. The insulator 150 may comprise a tape made of a resin material.

Portions of the electrode taps 130, 140, which are disposed in the sealing portion of the pouch case 110, are covered with an insulating polymer 160. The midsections 132, 142, are not insulated between the free ends 131, 141 and the polymer 160. A Protective Circuit Module (PCM) (not shown) is electrically connected to the midsections 132, 142. The length of the free ends 131, 141, is less than half of the combine lengths of the free ends 131, 141, and midsections 132, 142, i.e., are less than half the lengths of the extended portions. This ratio insures that the PCM can be easily connected to the midsections 132, 142.

FIG. 2 is a plan view of a secondary battery 200, according to another exemplary embodiment of the invention. The secondary battery 200 comprises an electrode assembly 120, a pouch case 110, a positive electrode tap 130, a negative electrode tap 140, and an insulator 250. The insulator 250 has a different construction than the insulator 150 of FIG. 1. Therefore, the following description of the secondary battery 200 is focused on the insulator 250, and omits descriptions of elements that are similar to previously described elements.

The insulator 250 has holes 251, 252 that expose portions of the free ends 131, 141. The electrode taps 130, 140 can be are electrically connected to the Protective Circuit Module (PCM), through the holes 251, 252, or via the midsections 132, 142. In other words, the electrode taps 130, 140 can be electrically connected to the Protective Circuit Module (PCM), via any combination of the holes 251, 252, or the midsections 132, 142. Accordingly, the location of the electrical connection, between the electrode taps 130, 140 and the Protective Circuit Module (PCM), may vary.

The insulator 250 is a single unit covering both of the electrode taps 130, 140. The insulator 250 prevents the positive electrode tap 130 and the negative electrode tap 140 from contacting one another, and forming a short circuit.

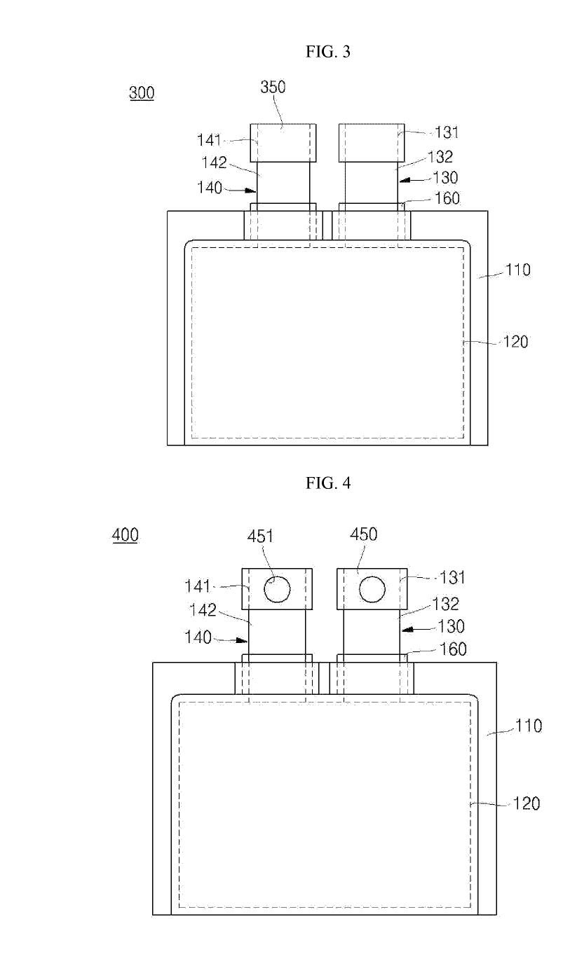

FIG. 3 is a plan view of a secondary battery 300, according to still another exemplary embodiment of the invention. The secondary battery 300 comprises an electrode assembly 120, a pouch case 110, a positive electrode tap 130, a negative electrode tap 140, and insulators 350. The insulators 350 differ from the previously described insulators. Therefore, the following description of the secondary battery 300 is focused on the insulators 350, and omits descriptions of elements that are similar to previously described elements.

The insulators 350 are separate units, and insulate free ends 131, 141 of the electrode taps 130, 140. The electrode taps 130, 140 can be electrically connected to a Protective Circuit Module (PCM), via the midsections 132, 142.

This insulators 350 allow the electrode taps 130, 140 to move independently, and at the same time, prevent a short circuit between the electrode taps 130, 140. The insulators 350 increase an operation efficiency, when electrically connecting the electrode taps 130, 140 to the Protective Circuit Module (PCM). The insulators 350 cover smaller portions of the electrode taps 130, 140, as compared with the insulators illustrated in FIG. 1 and FIG. 2, thereby reducing a total quantity of insulating material used to form the insulators 350.

FIG. 4 is a plan view of a secondary battery 400, according to still another exemplary embodiment of the invention. The secondary battery 400 comprises an electrode assembly 120, a pouch case 110, a positive electrode tap 130, a negative electrode tap 140, and insulators 450. The insulators 450 differ from the previously described insulators. Therefore, the following description of the secondary battery 400 is focused on the insulator, and omits descriptions of elements that are similar to previously described elements.

The insulators 450 separately cover and insulate the free ends of the electrode taps 130, 140. Each insulator 450 has a hole 451 exposing portions of the free ends 131, 141. The electrode taps 130, 140 can be electrically connected to the Protective Circuit Module (PCM), via the holes 451 or the midsections 132, 142.

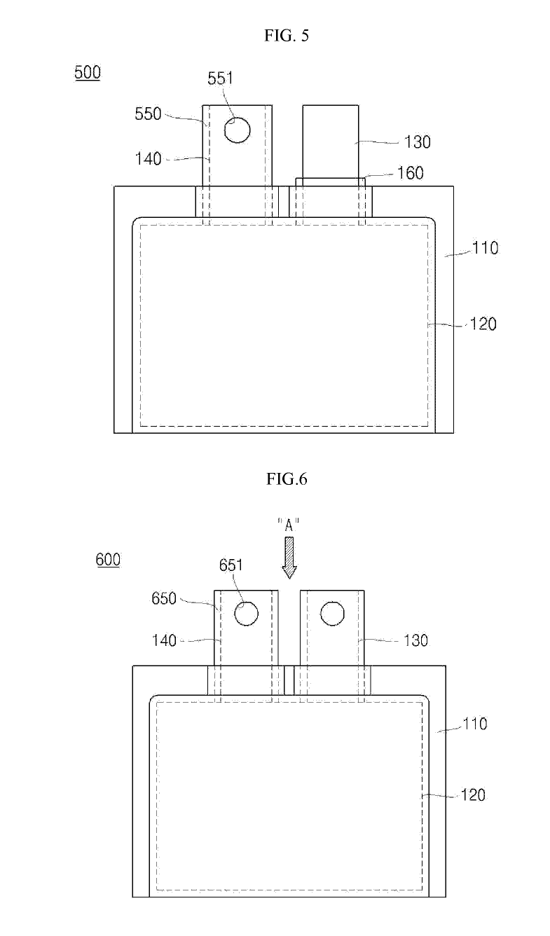

FIG. 5 is a plan view of a secondary battery 500, according to still another exemplary embodiment of the invention. The secondary battery 500 comprises an electrode assembly 120, a pouch case 110, a positive electrode tap 130, a negative electrode tap 140, and an insulator 550. The insulator 550 differs from the previously described insulators. Therefore, the following description of the secondary battery 500 is focused on the insulator 550, and omits descriptions of elements that are similar to previously described elements.

The insulator 550 entirely covers the extended portion of the negative electrode tap 140, which extends outward from of the sealing portion. However, the insulator can be disposed on either of the electrode taps 130, 140. The insulator 550 has a hole 551 formed therein, to expose part of the negative electrode tap 140. The insulator 550 can prevent a short circuit between the electrode taps 130, 140. Because the insulator 550 is formed on only one of the electrode taps 130, 140, the quantity of an insulator material used to form the insulator 550, and associated manufacturing costs, are reduced.

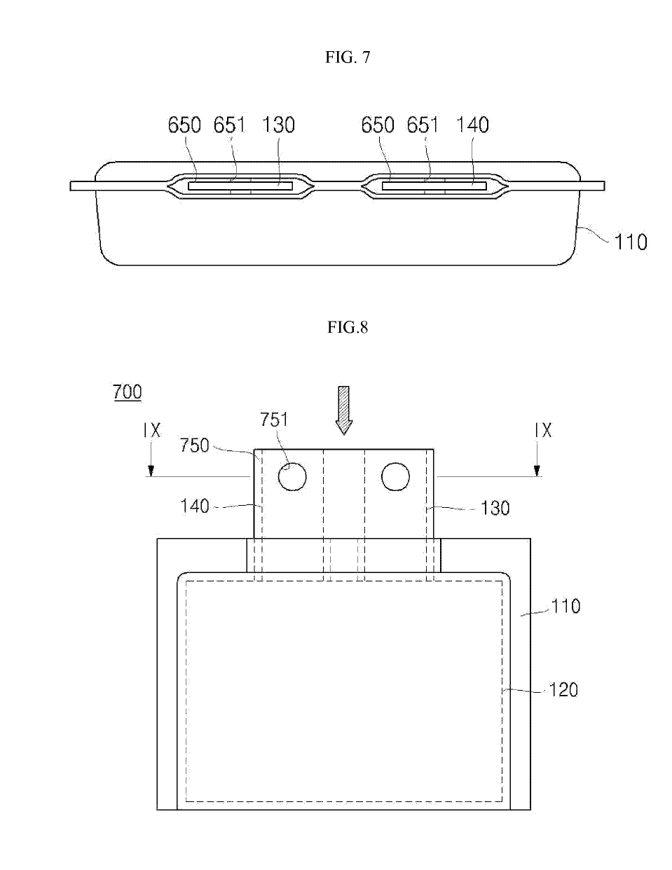

FIG. 6 is a plan view of a secondary battery 600, according to still another exemplary embodiment of the invention, and FIG. 7 is a lateral view shown in the direction of “A” in FIG. 6. The secondary battery 600 comprises an electrode assembly 120, a pouch case 110, a positive electrode tap 130, a negative electrode tap 140, and insulators 650. The insulators 650 differ from the previously described insulators. Therefore, the following description is focused on the insulators 650, and omits descriptions of elements that are similar to previously described elements.

The insulators 650 almost entirely cover the extended portions the electrode taps 130, 140. The insulators 650 have holes 651 to expose portions of the electrode taps 130, 140. The electrode taps 130, 140 are electrically connected to a Protective Circuit Module (PCM), via the holes 651.

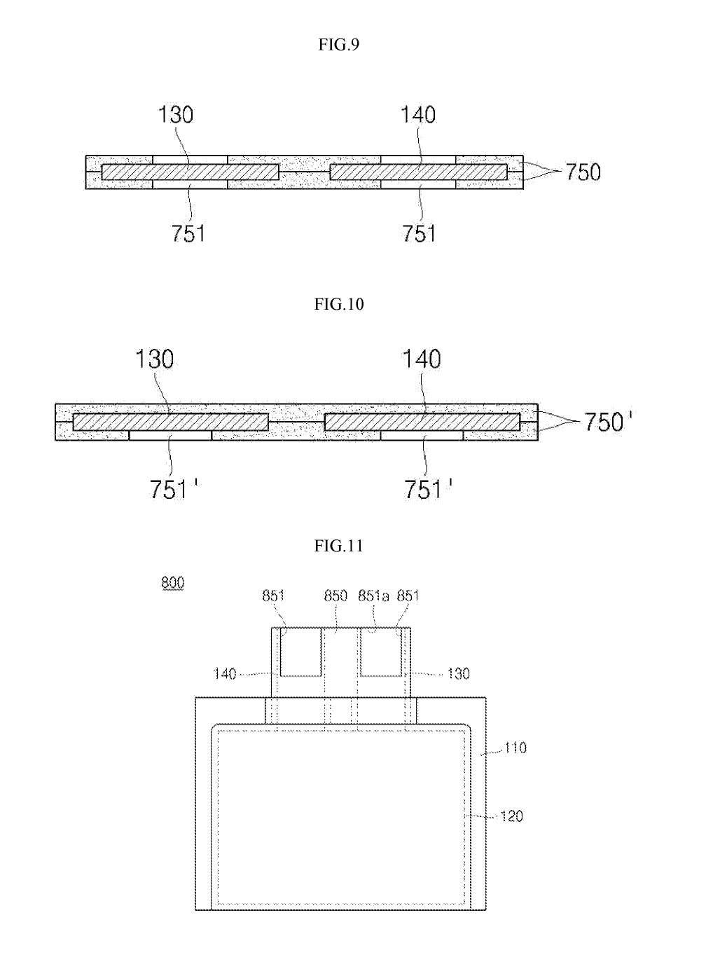

FIG. 8 is a plan view of the secondary battery 700, according to still another exemplary embodiment of the invention, FIG. 9 is a cross-sectional view taken along the line IX-IX of FIG. 8, and FIG. 10 is a cross-sectional view illustrating another exemplary embodiment, with regard to a part of the secondary battery 700.

The secondary battery 700 comprises an electrode assembly 120, a pouch case 110, a positive electrode tap 130, a negative electrode tap 140, and an insulator 750. The insulator 750 differs from the previously described insulators. Therefore, the following description of the secondary battery 700 is focused on the insulator 750, and omits descriptions of elements that are similar to previously described elements.

The insulator 750 is a single unit that covers both of the electrode taps 130, 140. As shown in FIG. 9, the insulator 750 has holes 751 to expose portions of the electrode taps 130, 140. The electrode taps 130, 140 are electrically connected to a Protective Circuit Module (PCM), via the holes 751.

The holes 751, as illustrated in FIG. 9, are disposed on opposing sides of each of the electrode taps 130, 140. Accordingly, electrode taps 130, 140 can be connected to a Protective Circuit Module (PCM), at either of the opposing sides, via the holes 751, thereby increasing operational efficiency. On the other hand, FIG. 10 illustrates holes 751′, which expose one side of the electrode taps 130, 140.

FIG. 11 is a plan view of a secondary battery 800, according to still another exemplary embodiment of the invention. The secondary battery 800 comprises an electrode assembly 120, a pouch case 110, a positive electrode tap 130, a negative electrode tap 140, and an insulator 850. The insulator 850 differs from the previously described insulators. Therefore, the following description of the secondary battery 800 is focused on the insulator 850, and omits descriptions of elements that are similar to previously described elements.

The insulator 850 is a single unit that covers both of the electrode taps 130, 140. The insulator 850 has holes 851 to expose portions of the electrode taps 130, 140. The holes 851 expose edges 851a of the electrode taps 130, 140. Accordingly, a Protective Circuit Module (PCM) can be slid into the holes 851, by passing over the edges 851a of the free ends 141. Thereby the Protective Circuit Module (PCM) can be more easily connected to the electrode taps 130, 140.

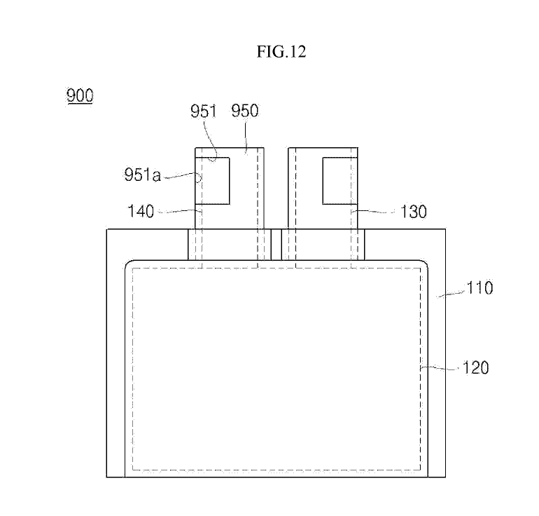

FIG. 12 is a plan view of a secondary battery 900, according to still another exemplary embodiment of the invention. The secondary battery 900 comprises an electrode assembly 120, a pouch case 110, a positive electrode tap 130, a negative electrode tap 140, and insulators 950. The insulators 950 differ from previously described insulators. Therefore, the following description of the secondary battery 900 is focused on the insulator 950, and omits descriptions of elements that are similar to previously described elements.

The insulators 950 separately cover the electrode taps 130, 140. The insulators 950 have holes 951 to expose side edges 951a of the electrode taps 130, 140. The holes 951 are disposed on opposing sides of the electrode taps 130, 140. Thus, an interval between connection terminals of the Protective Circuit Module (PCM) is wider, so as to enhance protection against a short circuit.

Although a few exemplary embodiments of the present invention have been shown and described, it would be appreciated by those skilled in the art that changes may be made in these exemplary embodiments, without departing from the principles and spirit of the invention, the scope of which is defined in the claims and their equivalents.

What is claimed is:

1. A pouch-type secondary battery comprising:
an electrode assembly comprising a positive electrode, a negative electrode, and a separator interposed between the positive and negative electrodes;
a pouch case to house the electrode assembly, having a sealing portion to seal the electrode assembly in the pouch case; and
a positive electrode tap that extends from the positive electrode, through the sealing portion, and having an extended portion which extends from the sealing portion, out of the pouch case;
a negative electrode tap that extends from the negative electrode, through the sealing portion, and having an extended portion, which extends from the sealing portion, out of the pouch case; and
an insulator that covers free ends of the extended portions.

2. The pouch-type secondary battery as claimed in claim 1, wherein the insulator covers less than half, lengthwise, of the extended portions.

3. The pouch-type secondary battery as claimed in claim 1, wherein the insulator is a single unit that extends between the electrode taps.

4. The pouch-type secondary battery as claimed in claim 1, wherein the insulator comprises a first unit that covers the positive electrode tap, and a separate second unit that covers the negative electrode tap.

5. The pouch-type secondary battery as claimed in claim 1, further comprising a polymer to insulate the positive and negative electrode taps from the sealing portion,
wherein the electrode taps have non-insulated midsections disposed between the polymer and insulator.

6. The pouch-type secondary battery as claimed in claim 1, wherein the insulator has holes that expose portions of the electrode taps.

7. The pouch-type secondary battery as claimed in claim 1, wherein the insulator is a tape made of a resin material.

8. A pouch-type secondary battery comprising:
an electrode assembly comprising a positive electrode, a negative electrode, and a separator interposed between the positive and negative electrodes;
a pouch case to house the electrode assembly, having a sealing portion to seal the electrode assembly in the pouch case;
a positive electrode tap that extends from the positive electrode, through the sealing portion, and out of the pouch case;
a negative electrode tap that extends from the negative electrode, through the sealing portion, and out of the pouch case; and
an insulator that covers one of the electrode taps.

9. The pouch-type secondary battery as claimed in claim 8, wherein the insulator extends along the entire length of the covered electrode tap, and has a hole that exposes a portion of electrode tap.

10. A pouch-type secondary battery comprising:
an electrode assembly comprising a positive electrode, a negative electrode, and a separator interposed between the positive and negative electrodes;
a pouch case to house the electrode assembly, having a sealing portion to seal the electrode assembly in the pouch case;
a positive electrode tap that extends from the positive electrode, through the sealing portion, and out of the pouch case;
a negative electrode tap that extends from the negative electrode, through the sealing portion, and out of the pouch case; and
an insulator that covers the electrode taps, that extends along the entire lengths of the electrode taps, and having holes to expose portions of the electrode taps.

11. The pouch-type secondary battery as claimed in claim 10, wherein the insulator is a single unit that extends between the electrode taps.

12. The pouch-type secondary battery as claimed in claim 10, wherein the insulator comprises a first unit that covers the positive electrode tap, and a separate second unit that covers the negative electrode tap.

13. The pouch-type secondary battery as claimed in claim 10, wherein the holes expose side edges of the electrode taps.

14. The pouch-type secondary battery as claimed in claim 10, wherein the holes expose top edges of the electrode taps.

15. The pouch-type secondary battery as claimed in claim 9, wherein the covered electrode tap is the negative electrode tap.

16. The pouch-type secondary battery as claimed in claim 13, wherein the exposed side edges face away from each other.
